(19) United States
(12) Patent Application Publication
(10) Pub. No.: US 2023/0083541 A1
(43) Pub. Date: Mar. 16, 2023

(54) IMPORTANCE CALCULATION APPARATUS, METHOD, AND NON-TRANSITORY COMPUTER READABLE MEDIUM

(71) Applicant: KABUSHIKI KAISHA TOSHIBA, Tokyo (JP)

(72) Inventors: Takahiro TANAKA, Akishima (JP); Kenichi DONIWA, Asaka (JP); Kosuke HARUKI, Tachikawa (JP); Masahiro OZAWA, Yokohama (JP)

(73) Assignee: KABUSHIKI KAISHA TOSHIBA, Tokyo (JP)

(21) Appl. No.: 17/682,271

(22) Filed: Feb. 28, 2022

(30) Foreign Application Priority Data
Sep. 15, 2021 (JP) 2021-150352

(51) Int. Cl. G06F 7/76; G06N 20/00

(52) U.S. Cl. CPC G06F 7/76; G06N 20/00

(57) ABSTRACT

According to one embodiment, an importance calculation apparatus includes a processing circuit. The processing circuit obtains data in which samples each including values regarding a plurality of explanatory variables and one response variable are arranged in a predetermined order. The processing circuit generates first data in which a first correspondence between the values of the plurality of explanatory variables and the values of the response variable is randomized between the samples in the data, and second data in which a correspondence between the values of at least one target explanatory variable among the plurality of explanatory variables and the values of the response variable is restored to the first correspondence in the first data.

### CROSS-REFERENCE TO RELATED APPLICATIONS

This application is based upon and claims the benefit of priority from Japanese Patent Application No. 2021-150352, filed Sep. 15, 2021, the entire contents of which are incorporated herein by reference.

### FIELD

Embodiments described herein relate generally to an importance calculation apparatus, method, and non-transitory computer readable medium.

### BACKGROUND

These days, machine learning has been applied to various tasks such as monitoring of manufacturing processes at factories and prediction of the disease risks. Especially for tasks regarding the human health like the latter case, the explanation of a machine learning model (to be referred to as a “model” hereinafter) used for prediction is required. An example of grounds for model-based prediction is variable importance representing the degree of contribution of a specific explanatory variable to prediction. The variable importance is evaluated by, for example, PI (Permutation Importance). The PI is calculated based on an increase of a prediction error obtained by inputting, to a model, data in which values regarding a specific explanatory variable included in test data are permutated at random between samples, in comparison with a prediction error obtained by inputting the test data to the model. The PI is closely associated with the prediction accuracy and easily intuitively understood as the variable importance.

However, when a plurality of explanatory variables have a strong correlation (multicollinearity), the PI is underestimated. This is because, even if the contribution of a specific explanatory variable to prediction is eliminated by permutating values regarding the explanatory variable at random between samples, the prediction is possible by another explanatory variable strongly correlated with the explanatory variable. Thus, the prediction error of the specific explanatory variable becomes smaller than a prediction error when there is no correlation. In the above case, the original variable importance of the explanatory variable subjected to calculation of the importance cannot be properly calculated.

### BRIEF DESCRIPTION OF THE DRAWINGS

FIG. 1 is a block diagram showing an example of the functional arrangement of an importance calculation apparatus according to the first embodiment;

FIG. 2 is a block diagram showing an example of the hardware arrangement of the importance calculation apparatus according to the first embodiment;

FIG. 3 is a flowchart showing an example of the operation of the importance calculation apparatus according to the first embodiment;

FIG. 4 is a table showing an example of test data;

FIG. 5 is a table showing the first example of the first data;

FIG. 6 is a table showing the first example of the second data;

FIG. 7 is a table showing the second example of the first data;

FIG. 8 is a table showing the second example of the second data;

FIG. 9 is a table showing an example of permutated data according to a conventional method;

FIG. 10 is a table showing another example of test data;

FIG. 11 is a graph showing an example of the use of the importance calculation apparatus according to the first embodiment;

FIG. 12 is a block diagram showing an example of the functional arrangement of an importance calculation apparatus according to the second embodiment;

FIG. 13 is a flowchart showing an example of the operation of the importance calculation apparatus according to the second embodiment;

FIG. 14 is a table showing the third example of the second data;

FIG. 15 is a table showing the fourth example of the second data;

FIG. 16 is a graph showing an example of the use of the importance calculation apparatus according to the second embodiment;

FIG. 17 is a graph showing another example of the use of the importance calculation apparatus according to the second embodiment;

FIG. 18 is a block diagram showing an example of the functional arrangement of an importance calculation apparatus according to the third embodiment;

FIG. 19 is a block diagram showing an example of the hardware arrangement of the importance calculation apparatus according to the third embodiment; and

FIG. 20 is a flowchart showing an example of the operation of the importance calculation apparatus according to the third embodiment.

### DETAILED DESCRIPTION

In general, according to one embodiment, an importance calculation apparatus includes a processing circuit. The processing circuit obtains data in which samples each including values regarding a plurality of explanatory variables and one response variable are arranged in a predetermined order. The processing circuit generates first data in which a first correspondence between the values of the plurality of explanatory variables and the values of the response variable is randomized between the samples in the data, and second data in which a correspondence between the values of at least one target explanatory variable among the plurality of explanatory variables and the values of the response variable is restored to the first correspondence in the first data. The processing circuit calculates a first predicted value for the values of the response variable based on the first data, and a second predicted value for the values of the response variable based on the second data. The processing circuit calculates a first prediction error between each value of the response variable and the first predicted value, and a second prediction error between each value of the response variable and the second predicted value. The processing circuit calculates an importance of the target explanatory variable based on the first prediction error and the second prediction error.

An importance calculation apparatus, a method, and a non-transitory computer readable medium according to embodiments will now be described with reference to the accompanying drawings. In the following embodiments, parts assigned with the same reference numerals perform similar operations and a repetitive description thereof will be omitted.

### First Embodiment

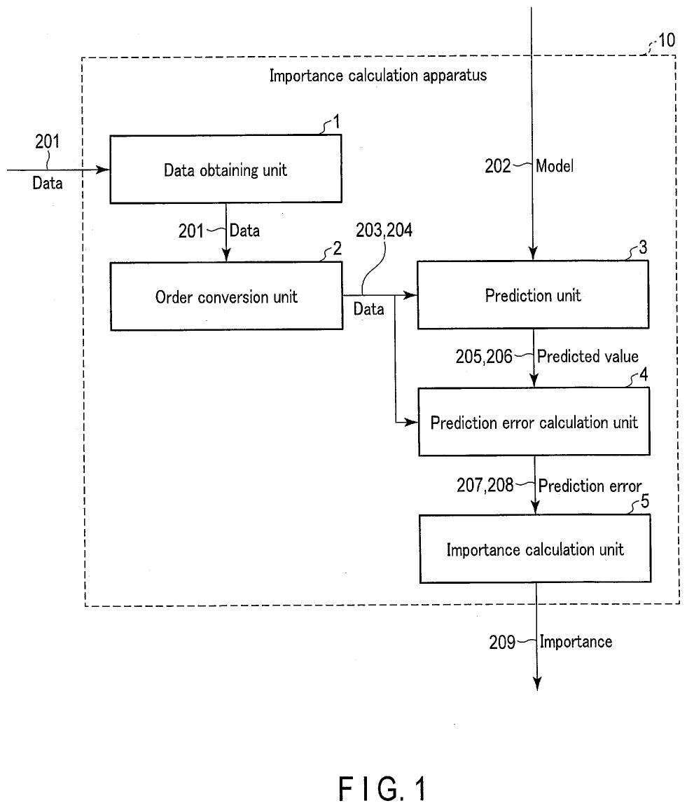

FIG. 1 is a block diagram showing an example of the functional arrangement of an importance calculation apparatus 10 according to the first embodiment. The importance calculation apparatus 10 is configured to calculate a variable importance regarding a specific explanatory variable (to be also referred to as a target explanatory variable). In the embodiment, the variable importance is assumed to be PI (Permutation Importance). The importance calculation apparatus 10 includes, as components, a data obtaining unit 1, an order conversion unit 2, a prediction unit 3, a prediction error calculation unit 4, and an importance calculation unit 5.

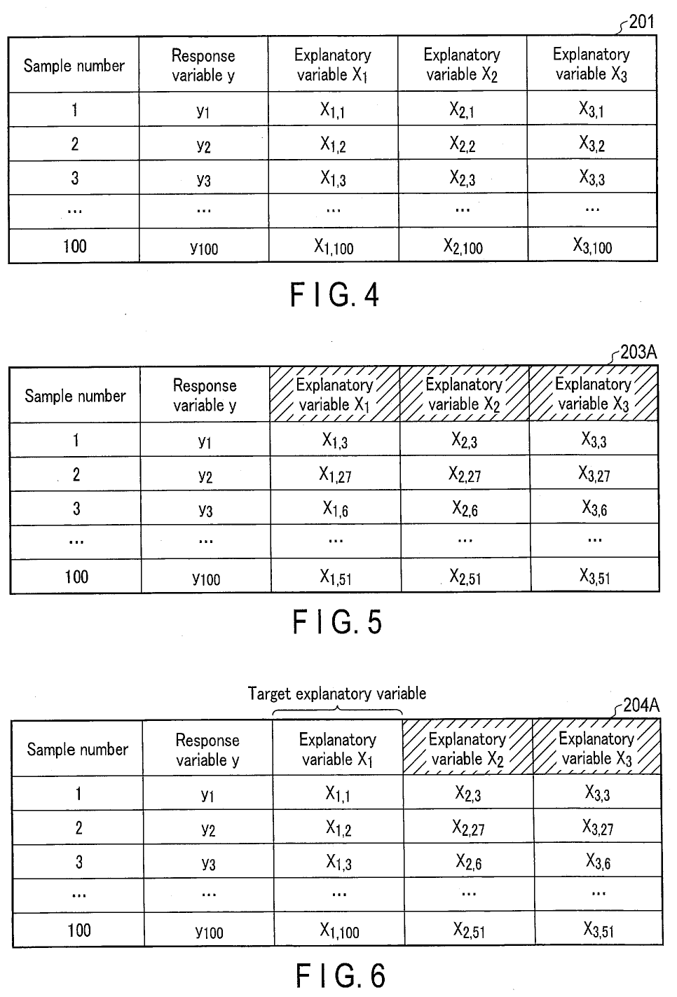

The data obtaining unit 1 obtains various data from outside the data obtaining unit 1. In the embodiment, the data obtaining unit 1 obtains data 201 (see FIG. 4) in which samples each including values regarding a plurality of explanatory variables and one response variable are arranged in a predetermined order. More specifically, the data 201 is data of a table format. The data 201 can be used to test the prediction accuracy of a model 202 trained in advance using training data similar to the data 201. From this viewpoint, the data 201 is also called test data or OOB (Out-Of-Bag) data. The data obtaining unit 1 outputs the obtained data 201 to the order conversion unit 2.

The order conversion unit 2 generates various data by converting the order of various data input from the data obtaining unit 1. In the embodiment, the order conversion unit 2 generates data 203 (to be also referred to as first data) in which the first correspondence between values of the explanatory variables and values of the response variable is randomized between samples in the data 201. Also, the order conversion unit 2 generates data 204 (to be also referred to as second data) in which the correspondence between values of one or more target explanatory variables among the explanatory variables and values of the response variable is restored to the first correspondence in the data 203. The first embodiment assumes one target explanatory variable. The order conversion unit 2 outputs the generated data 203 and 204 to each of the prediction unit 3 and the prediction error calculation unit 4. For example, the order conversion unit 2 generates the data 203 and 204 according to a method described in the following first or second example.

According to the first example, the order conversion unit 2 generates data 203A (see FIG. 5) in which values of the explanatory variables are permutated at random between the samples in the data 201. The order conversion unit 2 generates data 204A (see FIG. 6) in which values of the target explanatory variable are permutated in a predetermined order of the data 201 between samples in the data 203A.

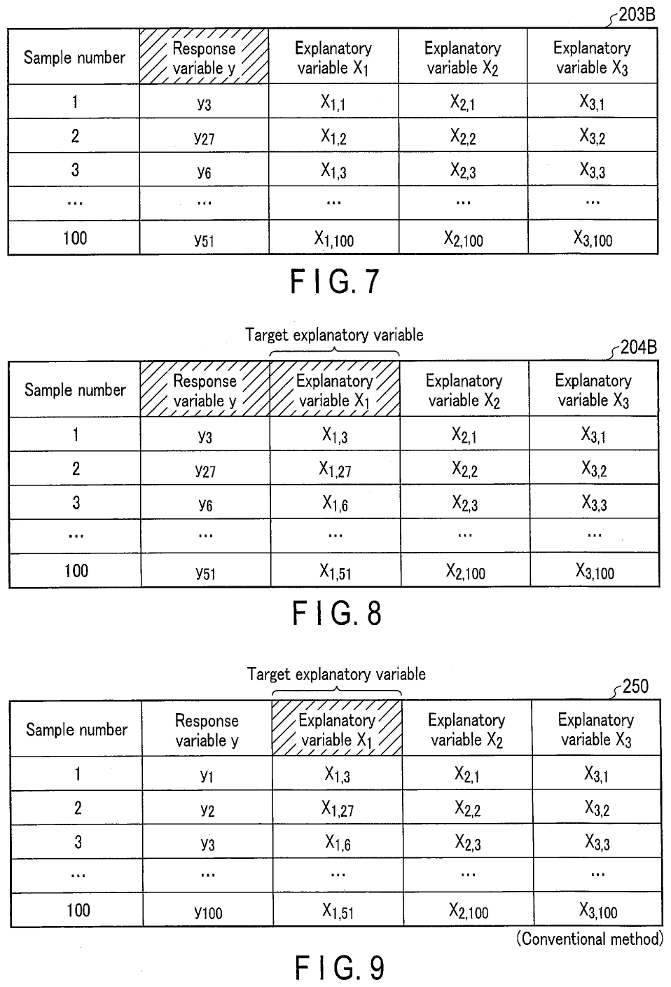

According to the second example, the order conversion unit 2 generates data 203B (see FIG. 7) in which values of the response variable are permutated in a random first order between the samples in the data 201. The order conversion unit 2 generates data 204B (see FIG. 8) in which values of the target explanatory variable are permutated in the first order between samples in the data 203B.

Both of the data 203A according to the first example and the data 203B according to the second example are examples of the data 203 in which the correspondence between values of the explanatory variables and values of the response variable is randomized between the samples in the data 201. Hence, permutating values of explanatory variables at random between samples by the order conversion unit 2, as in the first example, is synonymous with permutating values of a response variable at random between samples by the order conversion unit 2, as in the second example. On the other hand, the data 204A according to the first example and the data 204B according to the second example are examples of the data 204 in which the correspondence between values of the target explanatory variable and values of the response variable is restored in each of the data 203A and 203B to the correspondence (equivalent to the first correspondence) in the data 201. Thus, permutating values of the target explanatory variable in the predetermined order of the data 201 between the samples in the data 203A by the order conversion unit 2, as in the first example, is synonymous with permutating values of the target explanatory variable in the order (equivalent to the first order) of values of the response variable of the data 203B between samples in the data 203B by the order conversion unit 2, as in the second example.

The prediction unit 3 calculates various prediction results based on various data input from the order conversion unit 2. In the embodiment, the prediction unit 3 calculates a predicted value 205 (to be also referred to as a first predicted value) for values of the response variable based on the data 203. Also, the prediction unit 3 calculates a predicted value 206 (to be also referred to as a second predicted value) for values of the response variable based on the data 204. The prediction unit 3 calculates the predicted values 205 and 206 using the model 202 obtained from outside the prediction unit 3. That is, the prediction unit 3 may calculate the predicted values 205 and 206 by inputting the data 203 and 204 to the model 202. As the model 202, an arbitrary model can be properly used, including linear regression, decision tree, random forest, logistic regression, support vector machine, naive Bayes, k-nearest neighbor algorithm, clustering, association analysis, and neural network. More specifically, the prediction unit 3 calculates the predicted values 205 and 206 for values of the response variable based on values of the explanatory variables in the samples included in the data 203 and 204. The prediction unit 3 outputs the calculated predicted values 205 and 206 to the prediction error calculation unit 4.

The prediction error calculation unit 4 calculates various prediction errors based on various data input from the order conversion unit 2 and various prediction results input from the prediction unit 3. In the embodiment, the prediction error calculation unit 4 calculates a prediction error 207 (to be also referred to as a first prediction error) between each value of the response variable in the data 203 and the predicted value 205 based on the data 203 and the predicted value 205. Further, the prediction error calculation unit 4 calculates a prediction error 208 (to be also referred to as a second prediction error) between each value of the response variable in the data 204 and the predicted value 206 based on the data 204 and the predicted value 206. More specifically, the prediction error calculation unit 4 calculates the prediction errors 207 and 208 between each value of the response variable and the predicted values 205 and 206 in each sample included in the data 203 and 204. Needless to say, an arithmetic mean or geometric mean may be calculated for the prediction errors 207 and 208 calculated in each sample. The prediction error calculation unit 4 outputs the calculated prediction errors 207 and 208 to the importance calculation unit 5.

The importance calculation unit 5 calculates a variable importance regarding the target explanatory variable based on various prediction errors input from the prediction error calculation unit 4. In the embodiment, the importance calculation unit 5 calculates an importance 209 of the target explanatory variable based on the prediction errors 207 and 208. More specifically, the importance calculation unit 5 calculates a difference or change rate between the prediction errors 207 and 208 as the importance 209 of the target explanatory variable. The importance calculation unit 5 outputs the calculated importance 209 to outside the importance calculation unit 5.

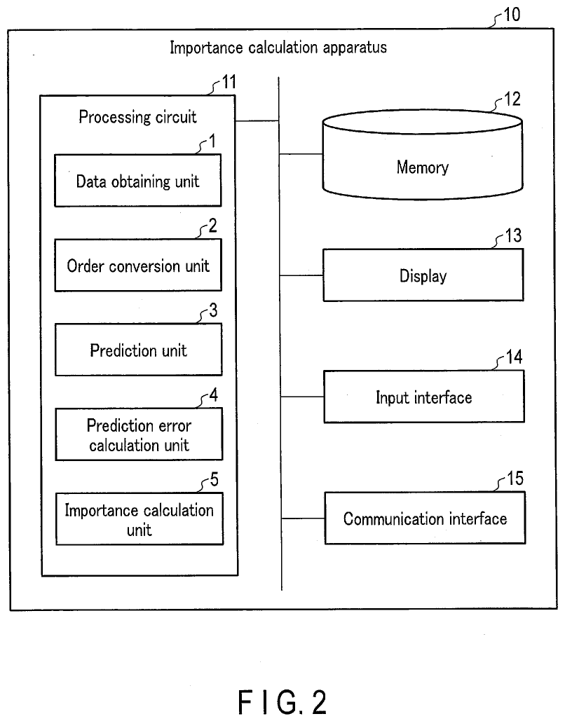

FIG. 2 is a block diagram showing an example of the hardware arrangement of the importance calculation apparatus 10 according to the first embodiment. The importance calculation apparatus 10 includes, as components, a processing circuit 11, a memory 12, a display 13, an input interface 14, and a communication interface 15. The components are connected via a bus serving as a common signal transmission line so that they can communicate with each other. Note that each component may not be implemented by each hardware. For example, at least two of the components may be implemented by one hardware.

The processing circuit 11 controls various operations of the importance calculation apparatus 10. The processing circuit 11 includes, as hardware, a processor such as a CPU (Central Processing Unit), a MPU (Micro Processing Unit), or a GPU (Graphics Processing Unit). The processing circuit 11 executes respective programs expanded in the memory 12 via the processor, implementing the respective units (data obtaining unit 1, order conversion unit 2, prediction unit 3, prediction error calculation unit 4, and importance calculation unit 5) corresponding to the respective programs. Note that each unit may not be implemented by the processing circuit 11 formed from a single processor. For example, each unit may be implemented by the processing circuit 11 formed from a combination of processors.

The memory 12 stores information such as data and programs used by the processing circuit 11. The memory 12 includes, as hardware, a semiconductor memory element such as a RAM (Random Access Memory). Note that the memory 12 may be a driving device that reads out/writes information from/in an external storage device such as a magnetic disk (floppy® disk or hard disk), a magneto-optical disk (MO), an optical disk (CD, DVD, or Blu-ray®), a flash memory (USB flash memory, memory card, or SSD), or a magnetic tape. The storage area of the memory 12 may be allocated inside the importance calculation apparatus 10 or an external storage device. In the embodiment, the memory 12 may store the data, 201, 203, and 204, the model 202, the predicted values 205 and 206, the prediction errors 207 and 208, and the importance 209.

The display 13 displays information such as data generated by the processing circuit 11 and data stored in the memory 12. As the display 13, for example, a display such as a CRT (Cathode Ray Tube) display, an LCD (Liquid Crystal Display), a plasma display, an OELD (Organic Electro-Luminescence Display), or a tablet terminal is properly available. In the embodiment, the display 13 may graph and display the importance 209 of a target explanatory variable. For example, the display 13 may display the importance 209 in the form of an arbitrary graph including a pictogram, bar chart, line chart, pie chart, band chart, histogram, and box plot. Note that the display 13 may display various kinds of information including the graph under the control of the processing circuit 11. The display 13 is an example of the display unit.

The input interface 14 accepts an input from the user of the importance calculation apparatus 10, converts the accepted input into an electric signal, and outputs the electric signal to the processing circuit 11. As the input interface 14, a physical operation component such as a mouse, keyboard, track ball, switch, button, joystick, touch pad, touch panel display, or microphone is properly available. The input interface 14 may be a device that accepts an input from an external input device other than the importance calculation apparatus 10, converts the accepted input into an electric signal, and outputs the electric signal to the processing circuit 11. The input interface 14 may accept from the user an input that designates a target explanatory variable among a plurality of explanatory variables included in the data 201. The user is, for example, an engineer who built the model 202. The input interface 14 may accept an input of group designation information 210 (see the second embodiment) that designates a group of two or more explanatory variables. The group designation information 210 may designate two or more explanatory variables generated from the same category data.

The communication interface 15 communicates various data between the inside and outside of the importance calculation apparatus 10. For this communication, an arbitrary wired or wireless communication standard is usable. In the embodiment, the communication interface 15 may obtain the data 201 and the model 202 from outside the importance calculation apparatus 10. The communication interface 15 may output the importance 209 to outside the importance calculation apparatus 10.

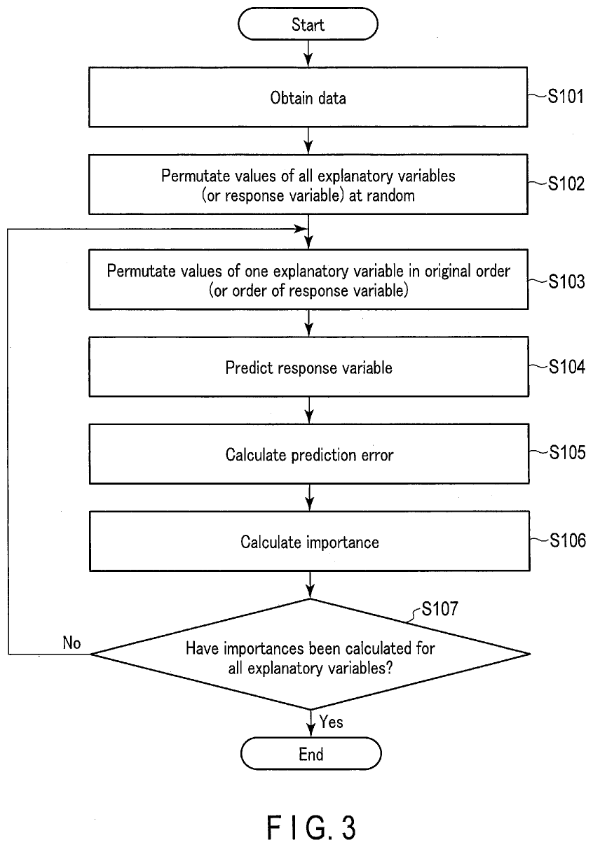

FIG. 3 is a flowchart showing an example of the operation of the importance calculation apparatus 10 according to the first embodiment. In step S101, the importance calculation apparatus 10 obtains data by the data obtaining unit 1. More specifically, the importance calculation apparatus 10 obtains the data 201 including values regarding a plurality of explanatory variables and one response variable.

In step S102, as the first example, the importance calculation apparatus 10 permutates values regarding all the explanatory variables at random by the order conversion unit 2. More specifically, the importance calculation apparatus 10 generates the data 203A by permutating, at random between samples, the values regarding all the explanatory variables included in the data 201. As the second example, the importance calculation apparatus 10 permutates values regarding the response variable at random by the order conversion unit 2. More specifically, the importance calculation apparatus 10 generates the data 203B by permutating, at random between the samples, the values regarding the response variable included in the data 201.

In step S103, as the first example, the importance calculation apparatus 10 permutates the values regarding one explanatory variable in an original order by the order conversion unit 2. More specifically, the importance calculation apparatus 10 generates the data 204A by permutating, between the samples in the order of the values regarding the response variable in the data 201, the values regarding one target explanatory variable among all the explanatory variables included in the data 203A. As the second example, the importance calculation apparatus 10 permutates the values regarding one explanatory variable in the order of the response variable by the order conversion unit 2. More specifically, the importance calculation apparatus 10 generates the data 204B by permutating, between the samples in the order (equivalent to the first order) of the values regarding the response variable in the data 203B, the values regarding one target explanatory variable among all the explanatory variables included in the data 203B.

In step S104, the importance calculation apparatus 10 predicts the response variable by the prediction unit 3. More specifically, as for the values of the response variable included in the data 203A or 203B, the importance calculation apparatus 10 calculates the predicted value 205 from the values of all the explanatory variables included in the data 203A or 203B. As for the values of the response variable included in the data 204A or 204B, the importance calculation apparatus 10 calculates the predicted value 206 from the values of all the explanatory variables included in the data 204A or 204B.

In step S105, the importance calculation apparatus 10 calculates a prediction error by the prediction error calculation unit 4. More specifically, the importance calculation apparatus 10 calculates the prediction error 207 between each value of the response variable included in the data 203A or 203B and the predicted value 205. In addition, the importance calculation apparatus 10 calculates the prediction error 208 between each value of the response variable included in the data 204A or 204B and the predicted value 206. For example, the importance calculation apparatus 10 may calculate the final prediction errors 207 and 208 by calculating the squared values of the prediction errors 207 and 208 calculated for the each sample and dividing the sums of the calculated squared values by the total number of samples. The final prediction error 207 or 208 is also called MSE (Mean Squared Error).

In step S106, the importance calculation apparatus 10 calculates an importance by the importance calculation unit 5. More specifically, the importance calculation apparatus 10 calculates the importance 209 of the target explanatory variable based on the prediction errors 207 and 208. The importance calculation apparatus 10 calculates a difference or change rate between the prediction errors 207 and 208 as the importance 209 of the target explanatory variable.

According to a given calculation method, the importance calculation apparatus 10 calculates, as the importance 209 of the target explanatory variable, a difference by subtracting the prediction error 208 from the prediction error 207 (equation: prediction error 207—prediction error 208). The prediction error 207 is a prediction error of the model 202 when no explanatory variable contributes to prediction performed by the model 202. To the contrary, the prediction error 208 is a prediction error of the model 202 when a target explanatory variable contributes to prediction performed by the model 202 and the remaining explanatory variables do not contribute. According to this calculation method, the importance 209 is calculated based on the degree of decrease of the prediction error 207 obtained when none of the explanatory variables contributes to prediction of the model 202, in comparison with the prediction error 208 obtained when the target explanatory variable contributes to prediction of the model 202. The calculated importance 209 does not include the contribution of the other explanatory variables correlated with the target explanatory variable, and thus can be regarded as the original variable importance of the target explanatory variable.

According to another calculation method, the importance calculation apparatus 10 calculates, as the importance 209 of the target explanatory variable, change rate by subtracting the prediction error 208 from the prediction error 207 and dividing the difference by the prediction error 207 (equation: (prediction error 207—prediction error 208)/prediction error 207). Similar to the above method, the importance 209 calculated by this method can be regarded as the original variable importance of the target explanatory variable.

In step S107, the importance calculation apparatus 10 determines whether importances have been calculated for all the explanatory variables. More specifically, the importance calculation apparatus 10 determines whether the importance 209 has been calculated for each of all the explanatory variables included in the data 201. If the importance calculation apparatus 10 determines that the importances 209 have not been calculated for all the explanatory variables (No in step S107), the process returns to step S103. Letting N (N is a natural number) be the number of explanatory variables subjected to calculation of the importance, a series of processes from step S103 to step S106 is executed N times. If the importance calculation apparatus 10 determines that the importances 209 have been calculated for all the explanatory variables (Yes in step S107), the process ends.

FIG. 4 is a table showing an example of test data (data 201). In the data 201, 100 samples (sample 1 to 100) each including values regarding three explanatory variables X₁, X₂, and X₃ and one response variable y are arranged in the ascending order of the sample number. For example, a value y₁ of the response variable y, a value X_{1.1} of the explanatory variable X₁, a value X_{2.1} of the explanatory variable X₂, and a value X_{3.1} of the explanatory variable X₃ are stored in “sample 1”. In other words, the values of the explanatory variables and the value of the response variable have a correspondence in “sample 1”. Similarly, in each of the other samples, the values of the explanatory variables and the value of the response variable have a correspondence. To represent a correspondence in each sample, the sample and the values of the respective variables stored in the sample include the same suffix. For example, “sample 1” and the values y₁, X_{1.1}, X_{2.1}, and X_{3.1} of the variables stored in “sample 1” include the same suffix “1”. More specifically, the suffix “_{1.1}” represents the value of the explanatory variable X₁ in “sample 1”, and the suffix “_{3.2}” represents the value of the explanatory variable X₃ in “sample 2”.

FIG. 5 is a table showing the first example (data 203A) of the first data. In the data 203A, values regarding all the explanatory variables included in the data 201 are permutated at random between the samples. More specifically, values regarding the three explanatory variables X₁, X₂, and X₃ are permutated at random between 100 samples in the data 203A. For example, the value y₁ of the response variable y₁ the value X_{1.3} of the explanatory variable X₁, the value X_{2.3} of the explanatory variable X₂, and the value X_{3.3} of the explanatory variable X₃ are stored in “sample 1”. Similarly, the value y₂ of the response variable y, the value X_{1.27} of the explanatory variable X₁, the value X_{2.27} of the explanatory variable X₂, and the value X_{3.27} of the explanatory variable X₃ are stored in “sample 2”. In this manner, the correspondence between values of the explanatory variables X₁, X₂, and X₃ and values of the response variable y in the data 201 is randomized between the samples in the data 203A.

In the embodiment, when randomizing values regarding all the explanatory variables in the data 201 by the importance calculation apparatus 10, it is enough to randomize the correspondence between values of the response variable and values of the explanatory variables while maintaining the correspondence between the values of the explanatory variables X₁, X₂, and X₃ for each sample of the data 201. FIG. 6 is a table showing the first example (data 204A) of the second data. In the data 204A, values regarding one target explanatory variable among all the explanatory variables included in the data 203A are permutated between the samples in the order of values regarding the response variable in the data 201. Here, the “explanatory variable X₁” is designated as the target explanatory variable among the three explanatory variables X₁, X₂, and X₃. For example, the value y₁ of the response variable y, the value X_{1.1} of the explanatory variable X₁, the value X_{2.3} of the explanatory variable X₂, and the value X_{3.3} of the explanatory variable X₃ are stored in “sample 1”. Similarly, the value y₂ of the response variable y, the value X_{1.2} of the explanatory variable X₁, the value X_{2.27} of the explanatory variable X₂, and the value X_{3.27} of the explanatory variable X₃ are stored in “sample 2”. In the data 204A, the correspondence between values of the target explanatory variable X₁ and values of the response variable y in the data 203A is restored to the correspondence in the data 201 between the samples. To the contrary, the correspondence between values of the other explanatory variables X₂ and X₃ and values of the response variable y in the data 204A is similar to the correspondence in the data 203A between the samples.

FIG. 7 is a table showing the second example (data 203B) of the first data. In the data 203B, values regarding the response variable included in the data 201 are permutated at random between the samples. More specifically, values regarding the response variable y are permutated at random between 100 samples in the data 203B. For example, the value y₃ of the response variable y, the value X_{1.1} of the explanatory variable X₁, the value X_{2.1} of the explanatory variable X₂, and the value X_{3.1} of the explanatory variable X₃ are stored in “sample 1”. Similarly, the value y₂₇ of the response variable y, the value X_{1.2} of the explanatory variable X₁, the value X_{2.2} of the explanatory variable X₂, and the value X_{3.2} of the explanatory variable X₃ are stored in “sample 2”. In this way, the correspondence between values of the explanatory variables X₁, X₂, and X₃ and values of the response variable y in the data 201 is randomized between the samples in the data 203B.

FIG. 8 is a table showing the second example (data 204B) of the second data. In the data 204B, values regarding one target explanatory variable among all the explanatory variables included in the data 203B are permutated between the samples in the order (equivalent to the first order) of values regarding the response variable in the data 203B. Here, the “explanatory variable X₁” is designated as the target explanatory variable among the three explanatory variables X₁, X₂, and X₃. For example, the value y₃ of the response variable y, the value X_{1.3} of the explanatory variable X₁, the value X_{2.1} of the explanatory variable X₂, and the value X_{3.1} of the explanatory variable X₃ are stored in “sample 1”. Similarly, the value y₂₇ of the response variable y, the value X_{1.27} of the explanatory variable X₁, the value X_{2.2} of the explanatory variable X₂, and the value X_{3.2} of the explanatory variable X₃ are stored in “sample 2”. In the data 204B, the correspondence between values of the target explanatory variable X₁ and values of the response variable y in the data 203B is restored to the correspondence in the data 201 between the samples. On the other hand, the correspondence between values of the other explanatory variables X₂ and X₃ and values of the response variable y in the data 204B is similar to the correspondence in the data 203B between the samples.

FIG. 9 is a table showing an example of permutated data 250 according to a conventional method. In the data 250, values regarding one target explanatory variable among all the explanatory variables included in the data 201 are permutated at random between the samples. Here, the “explanatory variable X₁” is designated as the target explanatory variable among the three explanatory variables X₁, X₂, and X₃. More specifically, values regarding the explanatory variable X₁ are permutated at random between 100 samples in the data 250. For example, the value y₁ of the response variable y, the value X_{1.3} of the explanatory variable X₁, the value X_{2.1} of the explanatory variable X₂, and the value X_{3.1} of the explanatory variable X₃ are stored in “sample 1”. Similarly, the value y₂ of the response variable y, the value X_{1.27} of the explanatory variable X₁, the value X_{2.2} of the explanatory variable X₂, and the value X_{3.2} of the explanatory variable X₃ are stored in “sample 2”.

A case in which a variable importance regarding one target explanatory variable is calculated based on the conventional method will be explained. According to the conventional method, the data 250 (see FIG. 9) is generated, in which values regarding the target explanatory variable are permutated at random between the samples in the data 201. Then, a difference or change rate between a prediction error (to be also referred to as a third prediction error) obtained by inputting the data 201 to the model 202, and a prediction error (to be also referred to as a fourth prediction error) obtained by inputting the data 250 to the model 202 is calculated as the importance of the target explanatory variable.

According to a given calculation method, a difference obtained by subtracting the third prediction error from the fourth prediction error (equation: fourth prediction error—third prediction error) is calculated as the importance of the target explanatory variable. The fourth prediction error is a prediction error of the model 202 when the target explanatory variable does not contribute to prediction performed by the model 202 but the remaining explanatory variables contribute. On the other hand, the third prediction error is a prediction error of the model 202 when all the explanatory variables contribute to prediction performed by the model 202. According to this calculation method, the importance of the target explanatory variable is calculated based on the degree of increase of the prediction error (fourth prediction error) obtained when the target explanatory variable does not contribute to prediction of the model 202, in comparison with the prediction error (third prediction error) obtained when all the explanatory variables contribute to prediction of the model 202.

However, the importance calculated by the above calculation method includes the contribution of the other explanatory variables correlated with the target explanatory variable. More specifically, the former prediction error (fourth prediction error) includes the contribution of the other explanatory variables correlated with the target explanatory variable, so the former prediction error becomes smaller than a prediction error when there is no correlation. Therefore, the importance calculated based on the conventional method is a value underestimated from the original variable importance of the target explanatory variable, and is not the original variable importance of the target explanatory variable.

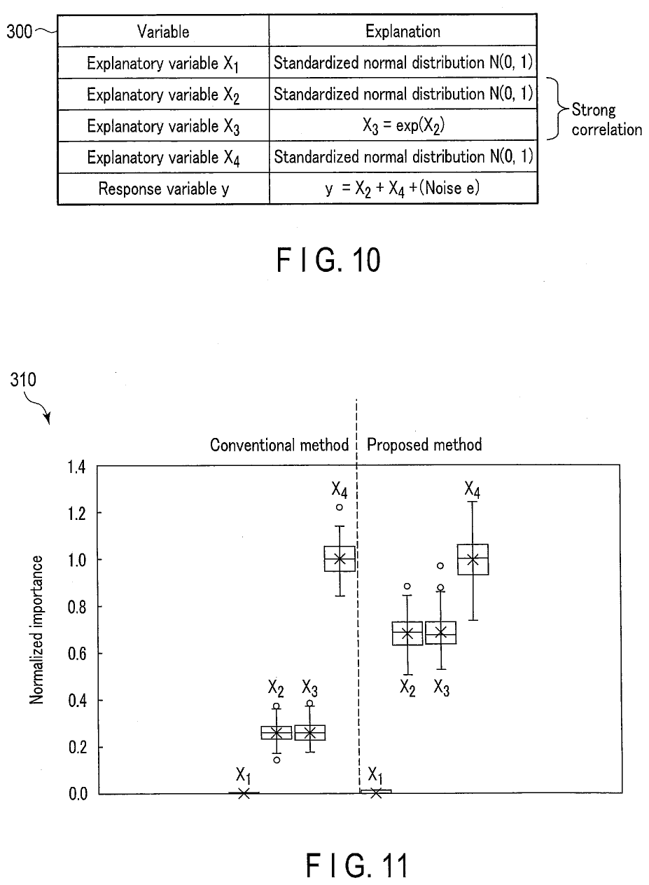

FIG. 10 is a table showing another example (data 300) of test data. The data 300 can be used to test the prediction accuracy of the model 202 trained in advance using training data similar to the data 300. The data 300 includes, as variables, a plurality of explanatory variables X₁, X₂, X₃, and X₄ and the response variable y. Among all the explanatory variables, the values of the explanatory variables X₁, X₂, and X₄ comply with a standardized normal distribution N(0, 1). The value of the remaining explanatory variable X₃ is uniquely determined by that of the explanatory variable X₂. That is, the explanatory variables X₂ and X₃ have a strong correlation. The value of the response variable y is uniquely determined by the values of the explanatory variables X₂ and X₄ and the value of noise e. That is, the value of the explanatory variable X₁ does not affect the value of the response variable y.

The importance calculation apparatus 10 calculates the importances of the explanatory variables X₁, X₂, X₃, and X₄ with respect to prediction of the model 202 using the data 300. Assume that the model 202 is a random forest and the value of a response variable is predicted from the values of explanatory variables. Note that the model 202 is not limited to the random forest and may be an arbitrary model used in machine learning. The importance calculation apparatus 10 calculates the importances of the explanatory variables using data regarding the remaining part of the data 300 not used for training with respect to the model 202 trained in advance using part of the data 300. The importance calculation apparatus 10 calculates the importances of the explanatory variables using the data 300 in a mode according to the proposed method (see FIG. 3). The calculated importances of the explanatory variables are displayed on the display 13, for example, like a graph 310 (see FIG. 11). The importance calculation apparatus 10 may calculate the importances of the explanatory variables using the data 300 in a mode according to the conventional method (see FIG. 9). Both the importances of the explanatory variables according to the conventional and proposed methods can be normalized and displayed on the display 13. When the importance calculation apparatus 10 displays only the importances of the explanatory variables according to the proposed method, the importances of the explanatory variables need not be normalized.

FIG. 11 is a graph showing an example of the use of the importance calculation apparatus 10 according to the first embodiment. In FIG. 11, the graph 310 represents the normalized importances of the explanatory variables calculated in modes according to the conventional and proposed methods. The importance calculation apparatus 10 calculates the importances of the explanatory variables using the data 300 in the mode according to the proposed method, and normalizes the calculated importances for comparison with the conventional method. The graph 310 is a box plot, but the display mode of the importance is not limited to this. As another display mode, at least only either the median or mean value of the importance may be displayed. Alternatively, only the importance of each explanatory variable according to the proposed method may be displayed. As is apparent from the graph 310, both the normalized importances of the explanatory variables X₂ and X₃ strongly correlated with each other exhibit relatively small values in the conventional method, and relatively large values in the proposed method.

The importance calculation apparatus 10 according to the first embodiment has been described above. As for test data (data 201) for testing the prediction accuracy of a machine learning model (model 202), the importance calculation apparatus 10 generates data (data 203) in which the correspondence between values of all explanatory variables and values of a response variable in the test data is randomized between samples. The importance calculation apparatus 10 generates data (data 204) in which the correspondence between values of one explanatory variable (target explanatory variable) subjected to calculation of the variable importance and values of the response variable in the randomized data is restored to the correspondence in the test data. Then, the importance calculation apparatus 10 inputs the data (data 203 and 204) generated from the test data to the machine learning model, causing the machine learning model to predict values of the response variable from the values of all the explanatory variables. Further, the importance calculation apparatus 10 calculates prediction errors (prediction errors 207 and 208) between the prediction results (predicted values 205 and 206) and the values of the response variable. Finally, based on the calculated prediction errors, the importance calculation apparatus 10 calculates the variable importance (importance 209) of one explanatory variable subjected to calculation of the variable importance.

The importance calculation apparatus 10 according to the first embodiment can properly calculate a variable importance. The importance calculation apparatus 10 graphs the calculated importance 209 and displays it on the display 13. The user can check the displayed importance 209 and confirm the original variable importance of a specific explanatory variable subjected to calculation of the importance. The user can rebuild the model 202 into an optimal one based on the displayed importance 209. For an explanatory variable that originally greatly contributes to prediction performed by the model 202, the importance calculation apparatus 10 can reduce the possibility at which the user passes over the explanatory variable as an unimportant one.

### Second Embodiment

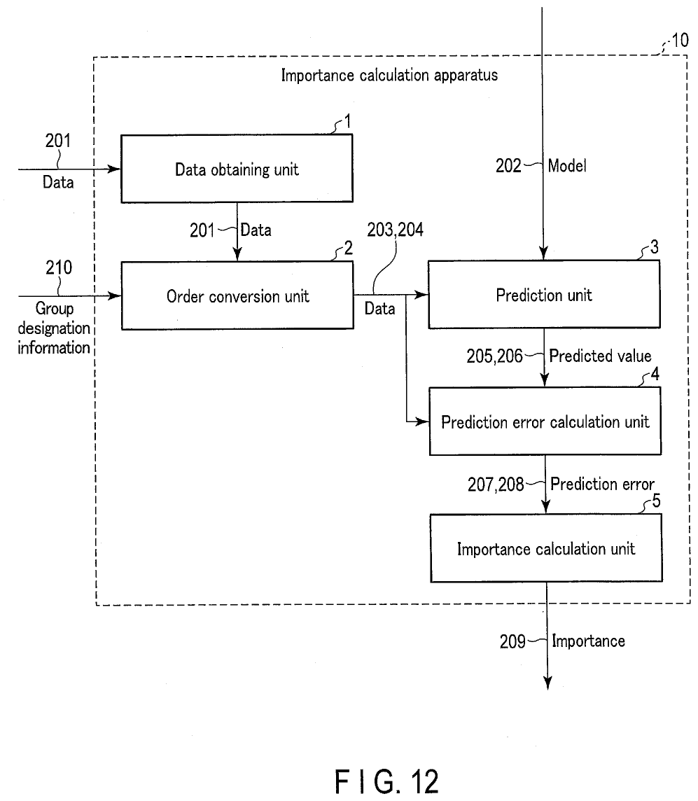

FIG. 12 is a block diagram showing an example of the functional arrangement of an importance calculation apparatus 10 according to the second embodiment. The hardware arrangement of the importance calculation apparatus 10 according to the second embodiment is similar to one according to the first embodiment, and a repetitive description thereof will be omitted. Unlike the first embodiment, group designation information 210 is input to an order conversion unit 2 according to the second embodiment.

The order conversion unit 2 obtains the group designation information 210 from outside the order conversion unit 2. The group designation information 210 is information that designates a group (to be also referred to as an explanatory variable group) of two or more explanatory variables. More specifically, the order conversion unit 2 generates data 204 using an explanatory variable group designated by the group designation information 210 as a target explanatory variable subjected to calculation of the importance. Note that the group designation information 210 may designate not only one explanatory variable group but also a plurality of explanatory variable groups. In this case, the order conversion unit 2 generates the data 204 using each of the explanatory variable groups designated by the group designation information 210 as a target explanatory variable. An importance calculation unit 5 calculates an importance 209 for each of the designated explanatory variable groups.

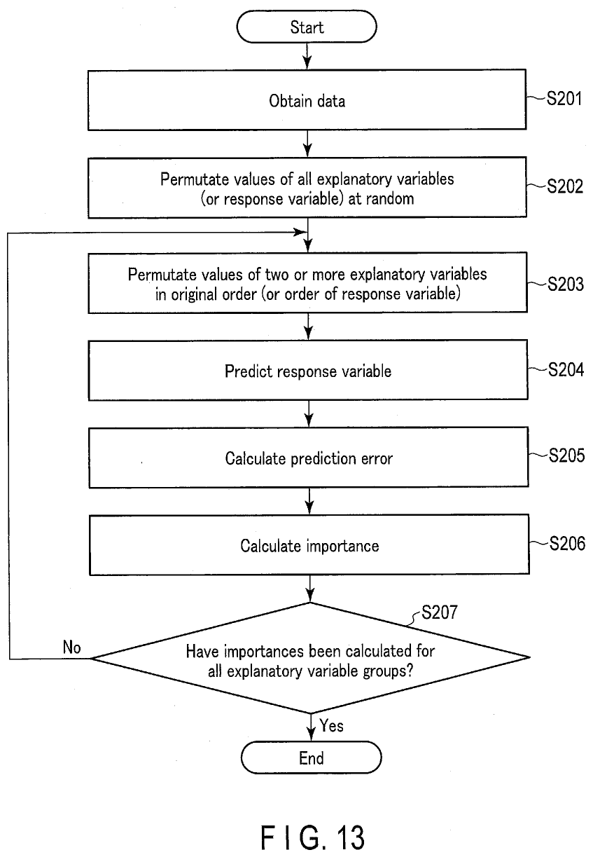

FIG. 13 is a flowchart showing an example of the operation of the importance calculation apparatus 10 according to the second embodiment. In step S201, the importance calculation apparatus 10 obtains data by a data obtaining unit 1. Step S201 is similar to step S101.

In step S202, the importance calculation apparatus 10 permutates values of all explanatory variables or a response variable at random by the order conversion unit 2. Step S202 is similar to step S102.

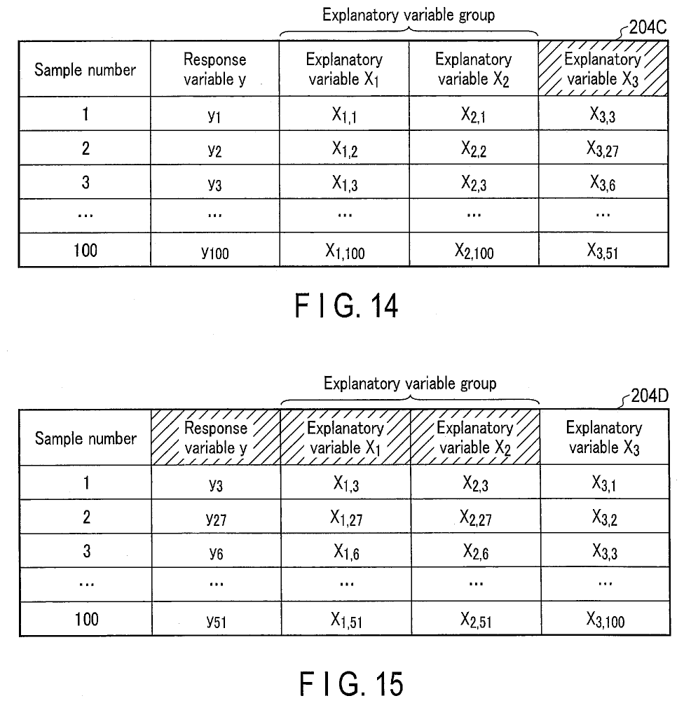

In step S203, as the first example, the importance calculation apparatus 10 permutates values of two or more explanatory variables in an original order by the order conversion unit 2. More specifically, the importance calculation apparatus 10 generates data 204C (see FIG. 14) by permutating, between samples in the order of values regarding the response variable in data 201, values regarding a group of two or more explanatory variables designated by the group designation information 210 among all the explanatory variables included in data 203A. As the second example, the importance calculation apparatus 10 permutates values of two or more explanatory variables in the order of the response variable by the order conversion unit 2. More specifically, the importance calculation apparatus 10 generates data 204D (see FIG. 15) by permutating, between the samples in the order (equivalent to the first order) of the values regarding the response variable in data 203B, the values regarding a group of two or more explanatory variables designated by the group designation information 210 among all the explanatory variables included in the data 203B.

In step S204, the importance calculation apparatus 10 predicts the response variable by a prediction unit 3. More specifically, the importance calculation apparatus 10 calculates a predicted value 205 for the values of the response variable included in the data 203A or 203B. Also, the importance calculation apparatus 10 calculates a predicted value 206 for the values of the response variable included in the data 204C or 204D.

In step S205, the importance calculation apparatus 10 calculates a prediction error by a prediction error calculation unit 4. More specifically, the importance calculation apparatus 10 calculates a prediction error 207 between each value of the response variable included in the data 203A or 203B and the predicted value 205. Further, the importance calculation apparatus 10 calculates a prediction error 208 between each value of the response variable included in the data 204C or 204D and the predicted value 206.

In step S206, the importance calculation apparatus 10 calculates an importance by the importance calculation unit 5. More specifically, the importance calculation apparatus 10 calculates an importance 209 of the explanatory variable group (equivalent to the target explanatory variable) based on the prediction errors 207 and 208. The importance calculation apparatus 10 calculates a difference or change rate between the prediction errors 207 and 208 as the importance 209 of the explanatory variable group.

In step S207, the importance calculation apparatus 10 determines whether importances have been calculated for all the explanatory variable groups. More specifically, the importance calculation apparatus 10 determines whether the importance 209 has been calculated for each of all the explanatory variable groups designated by the group designation information 210. If the importance calculation apparatus 10 determines that the importances 209 have not been calculated for all the explanatory variable groups (No in step S207), the process returns to step S203. Letting N be the number of explanatory variable groups subjected to calculation of the importance, a series of processes from step S203 to step S206 is executed N times. If the importance calculation apparatus 10 determines that the importances 209 have been calculated for all the explanatory variable groups (Yes in step S207), the process ends.

FIG. 14 is a table showing the third example (data 204C) of the second data. In the data 204C, values regarding one explanatory variable group among all the explanatory variables included in the data 203A are permutated between the samples in the order of values regarding the response variable in the data 201. Here, the “explanatory variables X₁ and X₂” are designated as the explanatory variable group among three explanatory variables X₁, X₂, and X₃. For example, the value y₁ of a response variable y, the value X_{1.1} of the explanatory variable X₁, the value X_{2.1} of the explanatory variable X₂, and the value X_{3.3} of the explanatory variable X₃ are stored in “sample 1”. Similarly, the value y₂ of the response variable y, the value X_{1.2} of the explanatory variable X₁, the value X_{2.2} of the explanatory variable X₂, and the value X_{3.27} of the explanatory variable X₃ are stored in “sample 2”. In the data 204C, the correspondence between values of the explanatory variable group (X₁, X₂) and values of the response variable y in the data 203A is restored to the correspondence in the data 201 between the samples. To the contrary, the correspondence between values of the other explanatory variable X₃ and values of the response variable y in the data 204C is similar to the correspondence in the data 203A between the samples.

FIG. 15 is a table showing the fourth example (data 204D) of the second data. In the data 204D, values regarding one explanatory variable group among all the explanatory variables included in the data 203B are permutated between the samples in the order (equivalent to the first order) of values regarding the response variable in the data 203B. Here, the “explanatory variables X₁ and X₂” are designated as the explanatory variable group among the three explanatory variables X₁, X₂, and X₃. For example, the value y₂ of the response variable y, the value X_{1.3} of the explanatory variable X₁, the value X_{2.3} of the explanatory variable X₂, and the value X_{3.1} of the explanatory variable X₃ are stored in “sample 1”. Similarly, the value y₂₇ of the response variable y, the value X_{1.27} of the explanatory variable X₁, the value X_{2.27} of the explanatory variable X₂, and the value X_{3.2} of the explanatory variable X₃ are stored in “sample 2”. In the data 204D, the correspondence between values of the explanatory variable group (X₁, X₂) and values of the response variable y in the data 203B is restored to the correspondence in the data 201 between the samples. On the other hand, the correspondence between values of the other explanatory variable X₃ and values of the response variable y in the data 204D is similar to the correspondence in the data 203B between the samples.

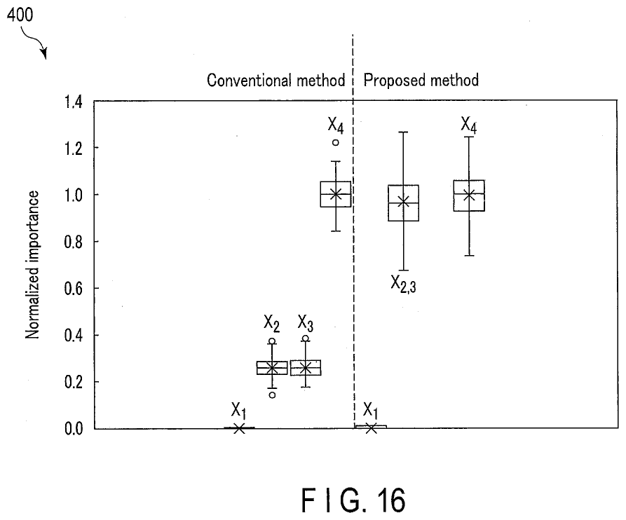

FIG. 16 is a graph showing an example of the use of the importance calculation apparatus 10 according to the second embodiment. In FIG. 16, a graph 400 represents the normalized importances of the explanatory variables calculated in modes according to the conventional and proposed methods. The graph 400 can be displayed in a mode similar to the graph 310 (see FIG. 11). Unlike the graph 310, the graph 400 represents a normalized importance regarding an explanatory variable X_{2.3} that is an aggregation of the explanatory variables X₂ and X₃ as an explanatory variable group. The median of the normalized importance of the explanatory variable group X_{2.3} according to the proposed method is almost equal to that of the normalized importance of the explanatory variable X₄ according to the proposed method. In this fashion, the importance calculation apparatus 10 regards two explanatory variables X₂ and X₃ strongly correlated with each other as one explanatory variable, and calculates a true effect size of this explanatory variable.

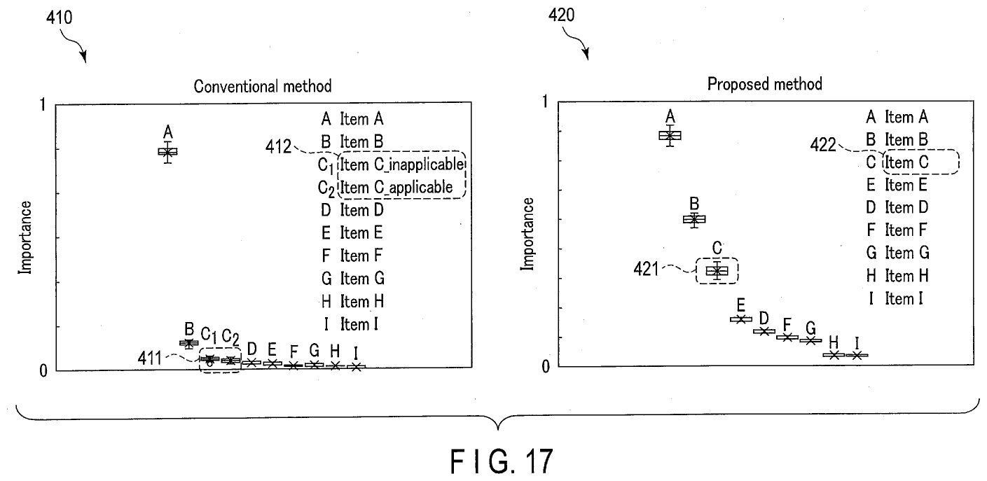

FIG. 17 is a graph showing another example of the use of the importance calculation apparatus 10 according to the second embodiment. In FIG. 17, graphs 410 and 420 represent the importances of the explanatory variables calculated in modes according to the conventional and proposed methods. The graphs 410 and 420 represent the importances of explanatory variables used for prediction by a model 202 that predicts the risk of a disease. The graphs 410 and 420 are box plots, but the display mode of the importance is not limited to this. As another display mode, at least only either the median or mean value of the importance may be displayed. When the importance calculation apparatus 10 displays only either the graph 410 or 420, the importance need not be normalized. Two types of data surrounded by a frame 411 of the graph 410 correspond to two types of explanatory variables “item C_inapplicable” and “item C_applicable” surrounded by a frame 412. Similarly, data surrounded by a frame 421 of the graph 420 corresponds to an explanatory variable “item C” surrounded by a frame 422.

The two types of explanatory variables are explanatory variables generated from the same category data. In general, a machine learning model cannot treat category data, so the category data needs to be converted into a data format treatable by the machine learning model. For example, letting N be the number of values that can be taken by given category data, N explanatory variables are newly generated and values are expressed by an N-dimensional one-hot vector. The importance calculation apparatus 10 can designate, by the group designation information 210, two or more explanatory variables generated from the same category data, and calculate the variable importance of the category data.

The importance calculation apparatus 10 according to the second embodiment has been described above. As for test data (data 201) for testing the prediction accuracy of a machine learning model (model 202), the importance calculation apparatus 10 generates data (data 203) in which the correspondence between values of all explanatory variables and values of a response variable in the test data is randomized between samples. The importance calculation apparatus 10 generates data (data 204) in which the correspondence between values of two or more explanatory variables (explanatory variable group) that are designated by the group designation information 210 and subjected to calculation of the variable importance, and values of the response variable in the randomized data is restored to the correspondence in the test data. Then, the importance calculation apparatus 10 inputs the data (data 203 and 204) generated from the test data to the machine learning model, causing the machine learning model to predict values of the response variable from the values of all the explanatory variables. Further, the importance calculation apparatus 10 calculates prediction errors (prediction errors 207 and 208) between the prediction results (predicted values 205 and 206) and the values of the response variable. Finally, based on the calculated prediction errors, the importance calculation apparatus 10 calculates the variable importance (importance 209) of two or more explanatory variables subjected to calculation of the variable importance.

The importance calculation apparatus 10 according to the second embodiment can properly calculate a variable importance. The importance calculation apparatus 10 can aggregate, as an explanatory variable group, two or more explanatory variables designated by the group designation information 210, and calculate a variable importance regarding the aggregated explanatory variable group. When the correlation between a given explanatory variable and another explanatory variable is sufficiently strong, the machine learning model can use either of the two explanatory variables and predict a response variable at almost the same prediction accuracy. In this case, it is not significant to discuss the magnitude of the value of the variable importance between the two explanatory variables. The importance calculation apparatus 10 can designate the two explanatory variables by the group designation information 210 and calculate the variable importance of the explanatory variable group, thereby calculating an original variable importance. That is, the importance calculation apparatus 10 can calculate a true effect size of a plurality of explanatory variables strongly correlated with each other.

### Third Embodiment

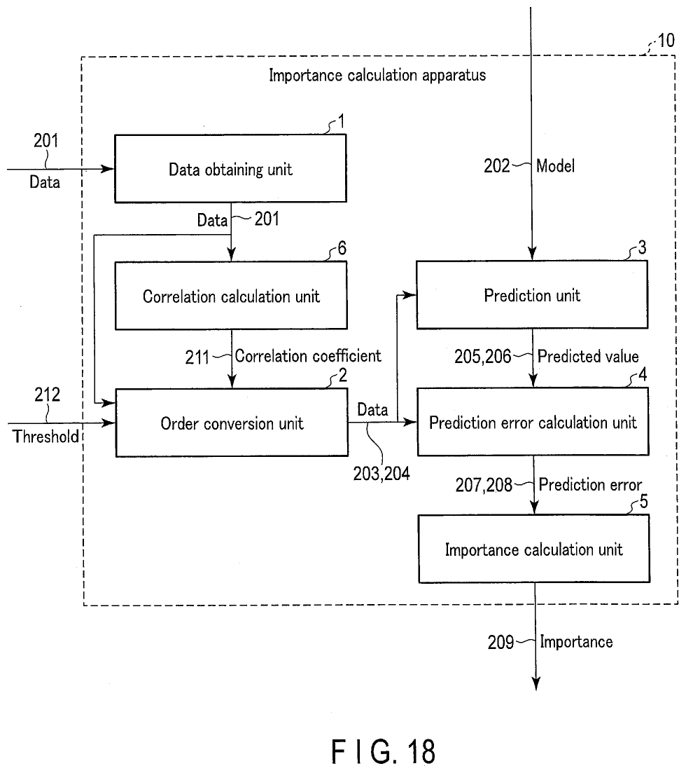

FIG. 18 is a block diagram showing an example of the functional arrangement of an importance calculation apparatus 10 according to the third embodiment. Unlike the first and second embodiments, the importance calculation apparatus 10 according to the third embodiment further includes a correlation calculation unit 6.

A data obtaining unit 1 obtains data 201 from outside the data obtaining unit 1. The data obtaining unit 1 outputs the obtained data 201 to an order conversion unit 2 and the correlation calculation unit 6.

The correlation calculation unit 6 calculates a correlation coefficient 211 for each pair (to be also referred to as an explanatory variable pair) of two explanatory variables included in a plurality of explanatory variables in the data 201 input from the data obtaining unit 1. The correlation coefficient 211 is an index representing the strength of a correlation between two explanatory variables. The correlation calculation unit 6 outputs the calculated correlation coefficient 211 to the order conversion unit 2.

Letting n (n is a natural number) be the number of all explanatory variables included in the data 201, the total number of combinations of explanatory variable pairs subjected to calculation of the correlation coefficient 211 is “ₙC₂”. That is, the correlation calculation unit 6 may calculate the correlation coefficient 211 for each of the explanatory variable pairs of this number. Needless to say, the correlation calculation unit 6 may output a correlation matrix of the calculated correlation coefficients 211 to the order conversion unit 2.

The order conversion unit 2 obtains a threshold 212 from outside the order conversion unit 2. The threshold 212 may be a value stored in advance in the order conversion unit 2 or a value input by the user via an input interface 14. Then, the order conversion unit 2 determines whether the correlation coefficient 211 calculated for each explanatory variable pair is equal to or higher than the threshold 212. If the correlation coefficient 211 of the explanatory variable pair is equal to or higher than the threshold 212, the order conversion unit 2 regards the explanatory variable pair as a target explanatory variable subjected to calculation of the importance. After that, the order conversion unit 2 generates data 203 and 204 by a method similar to those in the first and second embodiments. More specifically, the order conversion unit 2 permutates, at random between samples, values regarding the explanatory variable pair whose correlation coefficient 211 is equal to or higher than the threshold 212. An importance calculation unit 5 calculates an importance 209 for each explanatory variable pair.

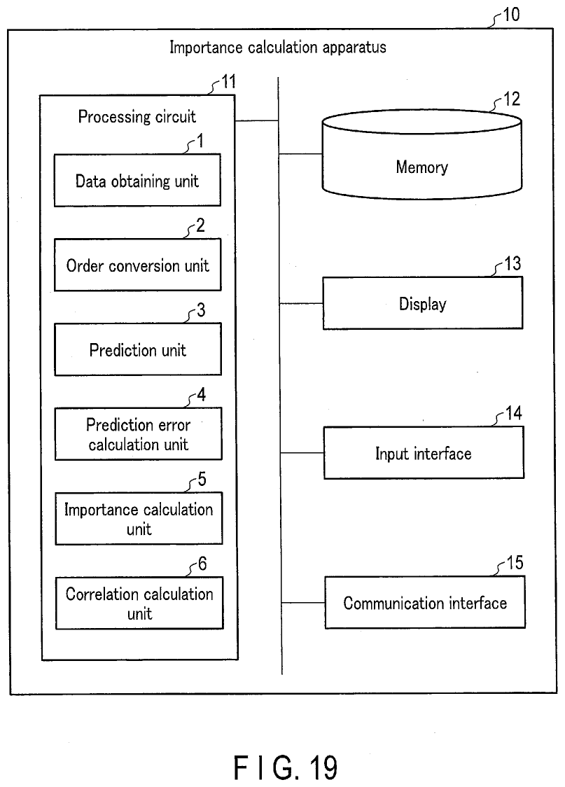

FIG. 19 is a block diagram showing an example of the hardware arrangement of the importance calculation apparatus 10 according to the third embodiment. Unlike the first and second embodiments, a processing circuit 11 according to the third embodiment further includes the correlation calculation unit 6.

In the embodiment, a memory 12 may store the correlation coefficient 211 and the threshold 212. A display 13 may graph and display the correlation coefficient 211. For example, the display 13 may display a correlation matrix of the calculated correlation coefficients 211 in a heatmap format. Further, the display 13 may graph and simultaneously display the importance 209 and the correlation coefficient 211.

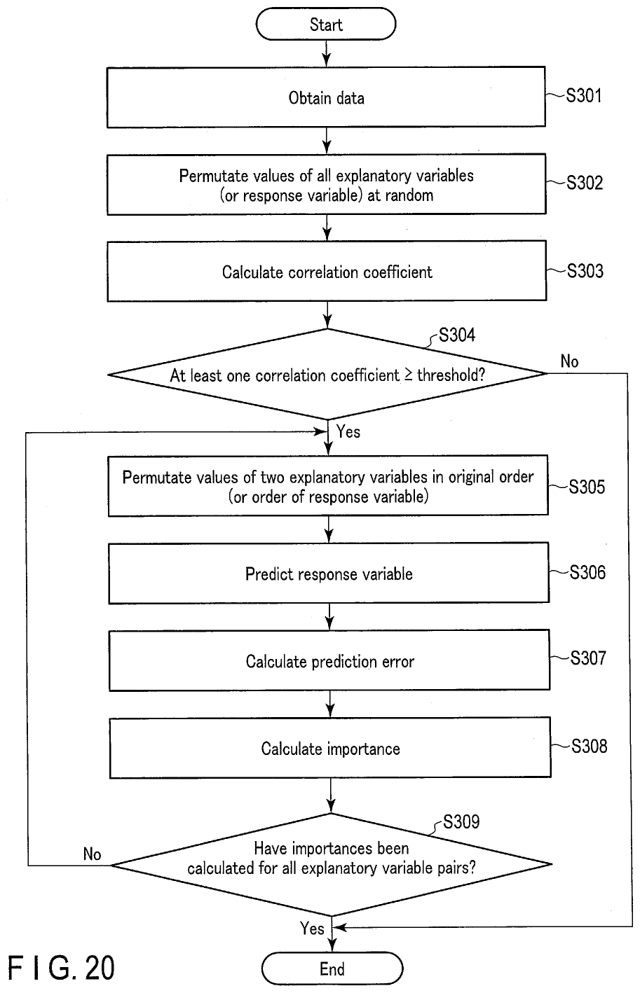

FIG. 20 is a flowchart showing an example of the operation of the importance calculation apparatus 10 according to the third embodiment. In step S301, the importance calculation apparatus 10 obtains data by the data obtaining unit 1. Step S301 is similar to step S101 and step S201.

In step S302, the importance calculation apparatus 10 permutates values of all explanatory variables or a response variable at random by the order conversion unit 2. Step S302 is similar to step S102 and step S202.

In step S303, the importance calculation apparatus 10 calculates a correlation coefficient by the correlation calculation unit 6. More specifically, the importance calculation apparatus 10 calculates the correlation coefficient 211 for each pair (explanatory variable pair) of two explanatory variables included in a plurality of explanatory variables in the data 201.

In step S304, the importance calculation apparatus 10 determines by the order conversion unit 2 whether the correlation coefficient is equal to or higher than the threshold. More specifically, the importance calculation apparatus 10 determines whether each calculated correlation coefficient 211 is equal to or higher than the threshold 212. If the importance calculation apparatus 10 determines that none of the correlation coefficients 211 is equal to or higher than the threshold 212, that is, the correlation coefficients 211 are lower than the threshold 212 (No in step S304), the process ends. If the importance calculation apparatus 10 determines that at least one correlation coefficients 211 is equal to or higher than the threshold 212 (Yes in step S304), the process advances to step S305.

In step S305, the importance calculation apparatus 10 permutates values of the two explanatory variables in an original order by the order conversion unit 2. More specifically, the importance calculation apparatus 10 generates data 204 by permutating, between samples in the order of values regarding the response variable in the data 201, values regarding, among all explanatory variables included in data 203A, a pair of two explanatory variables whose correlation coefficient 211 has been determined to be equal to or higher than the threshold 212. Alternatively, the importance calculation apparatus 10 permutates values of two explanatory variables in the order of the response variable by the order conversion unit 2. More specifically, the importance calculation apparatus 10 generates the data 204 by permutating, between the samples in the order (equivalent to the first order) of the values regarding the response variable in data 203B, the values regarding, among all explanatory variables included in data 203B, a pair of two explanatory variables whose correlation coefficient 211 has been determined to be equal to or higher than the threshold 212.

In step S306, the importance calculation apparatus 10 predicts the response variable by a prediction unit 3. More specifically, the importance calculation apparatus 10 calculates a predicted value 205 for the values of the response variable included in the data 203A or 203B. Also, the importance calculation apparatus 10 calculates a predicted value 206 for the values of the response variable included in the data 204.

In step S307, the importance calculation apparatus 10 calculates a prediction error by a prediction error calculation unit 4. More specifically, the importance calculation apparatus 10 calculates a prediction error 207 between each value of the response variable included in the data 203A or 203B and the predicted value 205. In addition, the importance calculation apparatus 10 calculates a prediction error 208 between each value of the response variable included in the data 204 and the predicted value 206.

In step S308, the importance calculation apparatus 10 calculates an importance by the importance calculation unit 5. More specifically, the importance calculation apparatus 10 calculates the importance 209 of the explanatory variable pair (equivalent to the target explanatory variable) based on the prediction errors 207 and 208. The importance calculation apparatus 10 calculates a difference or change rate between the prediction errors 207 and 208 as the importance 209 of the explanatory variable pair.

In step S309, the importance calculation apparatus 10 determines whether importances have been calculated for all the explanatory variable pairs. More specifically, the importance calculation apparatus 10 determines whether the importance 209 has been calculated for each of all the explanatory variable pairs whose correlation coefficients 211 have been determined to be equal to or higher than the threshold 212. If the importance calculation apparatus 10 determines that the importances 209 have not been calculated for all the explanatory variable pairs (No in step S309), the process returns to step S305. Letting N be the number of explanatory variable pairs subjected to calculation of the importance, a series of processes from step S305 to step S308 is executed N times. If the importance calculation apparatus 10 determines that the importances 209 have been calculated for all the explanatory variable pairs (Yes in step S309), the process ends.

The importance calculation apparatus 10 according to the third embodiment has been described above. As for test data (data 201) for testing the prediction accuracy of a machine learning model (model 202), the importance calculation apparatus 10 generates data (data 203) in which the correspondence between values of all explanatory variables and values of a response variable in the test data is randomized between samples. The importance calculation apparatus 10 calculates a correlation coefficient (correlation coefficient 211) for each explanatory variable pair of two explanatory variables among all the explanatory variables included in the test data. The importance calculation apparatus 10 generates data (data 204) in which the correspondence between values of two explanatory variables (explanatory variable pair) whose correlation coefficient has been determined to be equal to or higher than a threshold (threshold 212), and values of the response variable in the randomized data is restored to the correspondence in the test data. Then, the importance calculation apparatus 10 inputs the data (data 203 and 204) generated from the test data to the machine learning model, causing the machine learning model to predict values of the response variable from the values of all the explanatory variables. Further, the importance calculation apparatus 10 calculates prediction errors (prediction errors 207 and 208) between the prediction results (predicted values 205 and 206) and the values of the response variable. Finally, based on the calculated prediction errors, the importance calculation apparatus 10 calculates the variable importance (importance 209) of two explanatory variables subjected to calculation of the variable importance.

The importance calculation apparatus 10 according to the third embodiment can properly calculate a variable importance. The importance calculation apparatus 10 can automatically decide, in accordance with the strength of a correlation between two explanatory variables, an explanatory variable pair subjected to calculation of the importance. The importance calculation apparatus 10 can save the user from manually selecting an explanatory variable pair. Also, the importance calculation apparatus 10 can calculate an original true effect size of two explanatory variables strongly correlated with each other.

When one explanatory variable of an explanatory variable pair is a target explanatory variable, the order conversion unit 2 may generate the data 204 while decreasing a ratio at which values of the other explanatory variable of the explanatory variable pair are permutated between samples in the data 203 as the absolute value of the correlation coefficient of the explanatory variable pair is smaller. For example, assume that “R” is the correlation coefficient between the explanatory variables X₂ and X₃, and the explanatory variable X₂ is a target explanatory variable. In this case, the importance calculation apparatus 10 restores the correspondence between values of the target explanatory variable X₂ and values of the response variable y in the data 203 to the correspondence between the values of the target explanatory variable X₂ and the values of the response variable y in the data 201. In contrast, the importance calculation apparatus 10 restores the correspondence between values of the other explanatory variable X₃ and values of the response variable y in the data 203 to the correspondence between the values of the explanatory variable X₃ and the values of the response variable y in the data 201 at a lower ratio as the absolute value |R| of the correlation coefficient R is smaller. For example, when the explanatory variables X₂ and X₃ are not correlated (that is, |R|=0), the importance calculation apparatus 10 does not permutate values of the explanatory variable X₃ in the data 203. In other words, the importance calculation apparatus 10 performs an operation similar to that in the first embodiment in this case. When the explanatory variables X₂ and X₃ are sufficiently strongly correlated, the importance calculation apparatus 10 permutates values of the explanatory variable X₃ in the data 203 in an original order in the data 201. In other words, the importance calculation apparatus 10 performs an operation similar to that in the second embodiment in this case.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An importance calculation apparatus comprising:
a processing circuit configured to:
obtain data in which samples each including values regarding a plurality of explanatory variables and one response variable are arranged in a predetermined order;
generate first data in which a first correspondence between the values of the plurality of explanatory variables and the values of the response variable is randomized between the samples in the data, and second data in which a correspondence between the values of at least one target explanatory variable among the plurality of explanatory variables and the values of the response variable is restored to the first correspondence in the first data;
calculate a first predicted value for the values of the response variable based on the first data, and a second predicted value for the values of the response variable based on the second data;
calculate a first prediction error between each value of the response variable and the first predicted value, and a second prediction error between each value of the response variable and the second predicted value; and
calculate an importance of the target explanatory variable based on the first prediction error and the second prediction error.

2. The apparatus according to claim 1, wherein the processing circuit generates the first data in which the values of the plurality of explanatory variables are permutated at random between the samples in the data, and the second data in which the values of the target explanatory variable are permutated in the predetermined order of the data between the samples in the first data.

3. The apparatus according to claim 1, wherein the processing circuit generates the first data in which the values of the response variable are permutated in a random first order between the samples in the data, and the second data in which the values of the target explanatory variable are permutated in the first order between the samples in the first data.

4. The apparatus according to claim 1, wherein the processing circuit calculates the first predicted value and the second predicted value using a machine learning model.

5. The apparatus according to claim 1, wherein the processing circuit calculates, as the importance of the target explanatory variable, one of a difference and change rate between the first prediction error and the second prediction error.

6. The apparatus according to claim 1, wherein the processing circuit generates the second data using, as the target explanatory variable, a group of at least two explanatory variables designated by group designation information.

7. The apparatus according to claim 6, wherein the group designation information designates at least two explanatory variables generated from same category data.

8. The apparatus according to claim 1, wherein the processing circuit calculates a correlation coefficient for each pair of two explanatory variables included in the plurality of explanatory variables in the data, and generates the second data using, as the target explanatory variable, the pair having the correlation coefficient not lower than a threshold.

9. The apparatus according to claim 1, wherein the processing circuit calculates a correlation coefficient for each pair of two explanatory variables included in the plurality of explanatory variables in the data, and when one explanatory variable of the pair is the target explanatory variable, generates the second data while decreasing a ratio at which values of the other explanatory variable of the pair are permutated between the samples in the first data as an absolute value of a correlation coefficient regarding the pair is smaller.

10. The apparatus according to claim 1, wherein the processing circuit graphs the importance of the target explanatory variable and displays the importance on a display unit.

11. An importance calculation method comprising:
obtaining data in which samples each including values regarding a plurality of explanatory variables and one response variable are arranged in a predetermined order;
generating first data in which a first correspondence between the values of the plurality of explanatory variables and the values of the response variable is randomized between the samples in the data, and second data in which a correspondence between the values of at least one target explanatory variable among the plurality of explanatory variables and the values of the response variable is restored to the first correspondence in the first data;
calculating a first predicted value for the values of the response variable based on the first data, and a second predicted value for the values of the response variable based on the second data;
calculating a first prediction error between each value of the response variable and the first predicted value, and a second prediction error between each value of the response variable and the second predicted value; and
calculating an importance of the target explanatory variable based on the first prediction error and the second prediction error.

12. A non-transitory computer readable medium including computer executable instructions, wherein the instructions, when executed by a processor, cause the processor to perform a method comprising:
obtaining data in which samples each including values regarding a plurality of explanatory variables and one response variable are arranged in a predetermined order;
generating first data in which a first correspondence between the values of the plurality of explanatory variables and the values of the response variable is randomized between the samples in the data, and second data in which a correspondence between the values of at least one target explanatory variable among the plurality of explanatory variables and the values of the response variable is restored to the first correspondence in the first data;
calculating a first predicted value for the values of the response variable based on the first data, and a second predicted value for the values of the response variable based on the second data;
calculating a first prediction error between each value of the response variable and the first predicted value, and a second prediction error between each value of the response variable and the second predicted value; and
calculating an importance of the target explanatory variable based on the first prediction error and the second prediction error.
